(19) United States
(12) Patent Application Publication
(10) Pub. No.: US 2015/0214736 A1
(43) Pub. Date: Jul. 30, 2015

(54) CONTROL METHOD FOR SUPPLYING POWER

(71) Applicant: Nien-Hui Kung, HsinChu (TW)

(72) Inventor: Nien-Hui Kung, HsinChu (TW)

(73) Assignee: RICHTEK TECHNOLOGY CORPORATION, Chupei City (TW)

(21) Appl. No.: 14/166,063

(22) Filed: Jan. 28, 2014

(51) Int. Cl. H02J 1/14; H05B 33/08; H02J 9/06; H02J 7/00; H02M 3/156

(52) U.S. Cl. CPC H02J 1/14; H02J 7/0072; H02M 3/156; H02J 9/061; H05B 33/0884; H02J 7/0065

(57) ABSTRACT

The present invention discloses a control method for supplying power, including (a) determining whether a power-receiving device requires power and whether the power supply apparatus is coupled to the charging node; (b) when both questions of step (a) are determined yes, determining whether a power supply capability of the power supply apparatus is higher than a current threshold; (c) when it is determined yes in step (b), supplying power from the power supply apparatus to the power-receiving device; (d) when it is determined no in step (b), determining whether a charge storage quantity of the battery is higher than a threshold; (e) when it is determined yes in step (d), supplying power from the battery to the power-receiving device; and (f) when it is determined no in step (d), supplying power from the power supply apparatus to the battery.

### BACKGROUND OF THE INVENTION

1. Field of Invention

The present invention relates to a control method for supplying power; particularly, it relates to such power supply control method with effective priority control and good power utilization efficiency.

2. Description of Related Art

Please refer to FIG. 1A and FIG. 1B. FIG. 1A shows a block diagram, illustrating a hardware configuration where a conventional control method for supplying power is applied to. This conventional hardware configuration 10 for example can be a portable electronic device, such as a mobile phone, a notebook computer or a tablet computer. FIG. 1B shows an embodiment of a power stage which is applied in FIG. 1A. The conventional hardware configuration 10 includes a power supply apparatus 13, a switching regulator 11, plural current sources 19 (for example but not limited to two current sources 19, as shown in FIG. 1A), plural light emitting diodes (LEDs) 18 (for example but not limited to two LEDs 18, as shown in FIG. 1A) and a battery 12. The power supply apparatus 13, the switching regulator 11 and the current sources 19 are commonly coupled to a charging node VMID. Each current source 19 is coupled between a corresponding LED 18 and a node LEDVIN, i.e., each current source 19 is coupled between a corresponding LED 18 and the charging node VMID. The LEDs 18 which provides illumination for example can be a torch or a flash of a camera in the above-mentioned portable electronic device. The current sources 19 are controlled according to an internal signal or an external signal (not shown), to determine whether they should provide current for the corresponding LEDs 18 to illuminate.

The switching regulator 11 is coupled between the charging node VMID and the battery 12; the switching regulator 11 converts an input voltage VIN at an input terminal IN to an output voltage VOUT at an output terminal OUT. As shown in FIG. 1A, the input terminal IN is coupled between the power supply apparatus 13 and the charging node VMID, and the output terminal OUT is coupled between the switching regulator 11 and the battery 12. The switching regulator 11 includes a buck power stage 111 and a control circuit 112. As shown in FIG. 1B, the buck power stage 111 includes an upper gate switch P1, a lower gate switch N1 and an inductor L. The upper gate switch P1, the lower gate switch N1 and the inductor L are commonly and electrically connected to a switching node Lx. The buck power stage 111 is controlled by the control signal S1′ generated by the control circuit 112. In this prior art, the upper gate switch P1 for example can be a PMOS transistor, and the lower gate switch N1 for example can be an NMOS transistor.

In the conventional hardware configuration 10, there are two power-receiving devices, one of which is the battery 12 and the other of which is the output capacitor (or the LEDs and the current sources 19). In addition, in the conventional hardware configuration 10, there are two power supply sources, one of which is the battery 12 and the other of which is the external power from a power supply terminal through the power supply apparatus 13. The power-receiving devices do not always require power (e.g., the LEDs 18 may not be turned ON to illuminate or the output capacitor may not require to be charged; or, the battery 12 may not require to be charged). The power supply sources do not always exist (e.g., the power supply apparatus 13 may be disconnected from the input terminal IN; or, the battery 12 may not have sufficient charges to supply power). There are various possible scenarios by combinations of the above, and the prior art does not provide an effective control method for supplying power to an appropriate power-receiving device from an appropriate power supply source.

In view of the above, to overcome the drawbacks in the prior art, the present invention proposes a power supply control method with effective priority control and good power utilization efficiency.

### SUMMARY OF THE INVENTION

From one perspective, the present invention provides a control method for supplying power through a first path from a power supply apparatus to a battery via a bi-directional switching regulator under a charging mode and supplying power through a second path from the power supply apparatus to at least one power-receiving device under the charging mode, or supplying power through a third path from the battery to the at least one power-receiving device via the bi-directional switching regulator under a power supply mode, wherein the power supply apparatus, the bi-directional switching regulator and the at least one power-receiving device are commonly coupled to a charging node under the charging mode and the bi-directional switching regulator is coupled between the charging node and the battery; the control method for supplying power comprising the steps of: (a) determining whether the at least one power-receiving device requires power and whether the power supply apparatus is coupled to the charging node; (b) when both questions of step (a) are determined yes, determining whether a power supply capability of the power supply apparatus is higher than a current threshold; (c) when it is determined yes in step (b), supplying power through the second path from the power supply apparatus to the at least one power-receiving device; (d) when it is determined no in step (b), determining whether a charge storage quantity of the battery is higher than a quantity threshold; (e) when it is determined yes in step (d), supplying power through the third path from the battery to the at least one power-receiving device via the bi-directional switching regulator; and (f) when it is determined no in step (d), and when the power supply apparatus is coupled to the charging node, supplying power through the first path from the power supply apparatus to the battery via the bi-directional switching regulator.

In one embodiment, the step (c) further comprises: when it is determined yes in step (b), charging the battery through the first path with a remaining current obtained by subtracting a current required by the at least one power-receiving device from a current supplied by the power supply apparatus.

In one embodiment, the control method for supplying power further comprises: when it is determined by step (a) that the at least one power-receiving device requires power and the power supply apparatus is not coupled to the charging node, executing the following steps: (d1) determining whether the charge storage quantity of the battery is higher than the quantity threshold; and (e1) when it is determined yes in step (d1), supplying power through the third path from the battery to the at least one power-receiving device via the bi-directional switching regulator.

From another perspective, the present invention provides a control method for supplying power through a first path from a power supply apparatus to a battery via a bi-directional switching regulator under a charging mode and supplying power through a second path from the power supply apparatus to at least one power-receiving device under the charging mode, or supplying power through a third path from the battery to the at least one power-receiving device via the bi-directional switching regulator under a power supply mode, wherein the power supply apparatus, the bi-directional switching regulator and the at least one power-receiving device are commonly coupled to a charging node under the charging mode and the bi-directional switching regulator is coupled between the charging node and the battery; the control method for supplying power comprising the steps of: (a) when the at least one power-receiving device requires power but the power supply apparatus is not coupled to the charging node, supplying power through the third path from the battery to the at least one power-receiving device via the bi-directional switching regulator; (b) subsequent to step (a), determining whether the power supply apparatus is coupled to the charging node; (c) when it is determined no in step (b), keeping supplying power from the battery to the at least one power-receiving device via the bi-directional switching regulator; and (d) when it is determined yes in step (b), blocking a current supplied by the power supply apparatus from flowing into the charging node and keeping supplying power from the battery to the at least one power-receiving device via the bi-directional switching regulator.

In one embodiment, the control method for supplying power further comprises: (e) after a predetermined period of time subsequent to the step (d), determining whether the at least one power-receiving device still requires power; (f) when it is determined yes in step (e), keeping blocking the current supplied by the power supply apparatus from flowing into the charging node and keeping supplying power from the battery to the at least one power-receiving device via the bi-directional switching regulator; and (g) when it is determined no in step (e), ceasing blocking the current supplied by the power supply apparatus from flowing into the charging node and ceasing supplying power from the battery to the at least one power-receiving device via the bi-directional switching regulator, and supplying power through the first path from the power supply apparatus to the battery via the bi-directional switching regulator.

From yet another perspective, the present invention provides a control method for supplying power through a first path from a power supply apparatus to a battery via a bi-directional switching regulator under a charging mode and supplying power through a second path from the power supply apparatus to at least one power-receiving device under the charging mode, or supplying power through a third path from the battery to the at least one power-receiving device via the bi-directional switching regulator under a power supply mode, wherein the power supply apparatus, the bi-directional switching regulator and the at least one power-receiving device are commonly coupled to a charging node under the charging mode and the bi-directional switching regulator is coupled between the charging node and the battery; the control method for supplying power comprising the steps of: (a) supplying power through the first path from the power supply apparatus to the battery via the bi-directional switching regulator; (b) determining whether the at least one power-receiving device requires power; (c) when it is determined no in step (b), keeping supplying power through the first path from the power supply apparatus to the battery via the bi-directional switching regulator; (d) when it is determined yes in step (b), ceasing supplying power from the power supply apparatus to the battery via the bi-directional switching regulator and blocking a current supplied by the power supply apparatus from flowing into the charging node; and (e) subsequent to the step (d), supplying power through the third path from the battery to the at least one power-receiving device via the bi-directional switching regulator.

In one embodiment, the control method for supplying power further comprises: (e) after a predetermined period of time subsequent to the step (d), determining whether the at least one power-receiving device still requires power; (f) when it is determined yes in step (e), keeping blocking the current supplied by the power supply apparatus from flowing into the charging node and keeping supplying power from the battery to the at least one power-receiving device via the bi-directional switching regulator; and (g) when it is determined no in step (e), ceasing blocking the current supplied by the power supply apparatus from flowing into the charging node and ceasing supplying power from the battery to the at least one power-receiving device via the bi-directional switching regulator, and supplying power through the first path from the power supply apparatus to the battery via the bi-directional switching regulator.

From still another perspective, the present invention provides a control method for supplying power through a first path from a power supply apparatus to a battery via a bi-directional switching regulator under a charging mode and supplying power through a second path from the power supply apparatus to at least one power-receiving device under the charging mode, or supplying power through a third path from the battery to the at least one power-receiving device via the bi-directional switching regulator under a power supply mode, wherein the power supply apparatus, the bi-directional switching regulator and the at least one power-receiving device are commonly coupled to a charging node under the charging mode and the bi-directional switching regulator is coupled between the charging node and the battery; the control method for supplying power comprising the steps of: (a) supplying power through the first path from the power supply apparatus to the battery via the bi-directional switching regulator; (b) determining whether the at least one power-receiving device requires power; (c) when it is determined no in step (b), keeping supplying power through the first path from the power supply apparatus to the at least one power-receiving device via the bi-directional switching regulator; (d) when it is determined yes in step (b), determining whether a power supply capability of the power supply apparatus is higher than a current threshold; (e) when it is determined yes in step (d), supplying power through the second path from the power supply apparatus to the at least one power-receiving device; (f) when it is determined no in step (d), determining whether a charge storage quantity of the battery is higher than a quantity threshold; (g) when it is determined yes in step (f), supplying power through the third path from the battery to the at least one power-receiving device via the bi-directional switching regulator; and (h) when it is determined no in step (f), supplying power through the first path from the power supply apparatus to the battery via the bi-directional switching regulator.

In one embodiment, the step (e) further comprises: when it is determined yes in step (d), charging the battery through the first path with a remaining current obtained by subtracting a current required by the at least one power-receiving device from a current supplied by the power supply apparatus.

From still another perspective, the present invention provides a control method for supplying power through a first path from a power supply apparatus to a battery via a bi-directional switching regulator under a charging mode and supplying power through a second path from the power supply apparatus to at least one power-receiving device under the charging mode, or supplying power through a third path from the battery to the at least one power-receiving device via the bi-directional switching regulator under a power supply mode, wherein the power supply apparatus, the bi-directional switching regulator and the at least one power-receiving device are commonly coupled to a charging node under the charging mode and the bi-directional switching regulator is coupled between the charging node and the battery; the control method for supplying power comprising the steps of: (a) supplying power through the first path from the power supply apparatus to the battery via the bi-directional switching regulator; (b) determining whether the at least one power-receiving device requires power; (c) when it is determined no in step (b), keeping supplying power from the power supply apparatus to the battery via the bi-directional switching regulator; (d) when it is determined yes in step (b), supplying power from both the power supply apparatus and the battery to the at least one power-receiving device; and (e) regulating a voltage of the charging node to a predetermined voltage level.

In one embodiment, the at least one power-receiving device includes at least one light emitting diode (LED).

In one embodiment, when supplying power from the power supply apparatus to the battery via the bi-directional switching regulator, the bi-directional switching regulator operates under a buck mode to perform a buck conversion; and when supplying power from the battery to the at least one power-receiving device via the bi-directional switching regulator, the bi-directional switching regulator operates under a boost mode to perform a boost conversion.

The objectives, technical details, features, and effects of the present invention will be better understood with regard to the detailed description of the embodiments below, with reference to the attached drawings.

### BRIEF DESCRIPTION OF THE DRAWINGS

FIG. 1A shows a block diagram, illustrating a hardware configuration where a conventional control method for supplying power is applied to.

FIG. 1B shows an embodiment of a power stage which is applied in FIG. 1A.

FIG. 2 shows a block diagram, illustrating an embodiment of a hardware configuration where a control method for supplying power according to the present invention can be applied to.

FIG. 3 shows an embodiment of the power stage of the present invention.

FIGS. 4-5 show several embodiments of the power protection switch.

FIGS. 6-11 show flowcharts, illustrating several embodiments of the control method for supplying power according to the present invention.

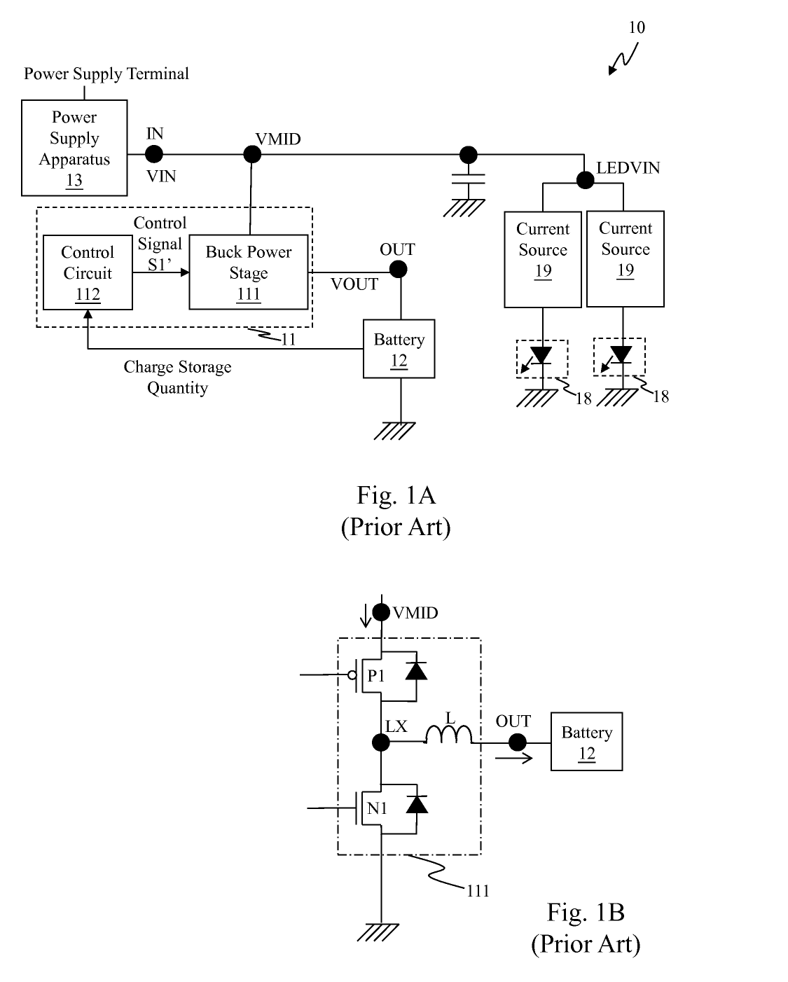

### DESCRIPTION OF THE PREFERRED EMBODIMENTS

The above and other technical details, features and effects of the present invention will be will be better understood with regard to the detailed description of the embodiments below, with reference to the drawings. The drawings as referred to throughout the description of the present invention are for illustration only, to show the interrelations between the apparatus, circuits and devices, but not drawn according to actual scale.

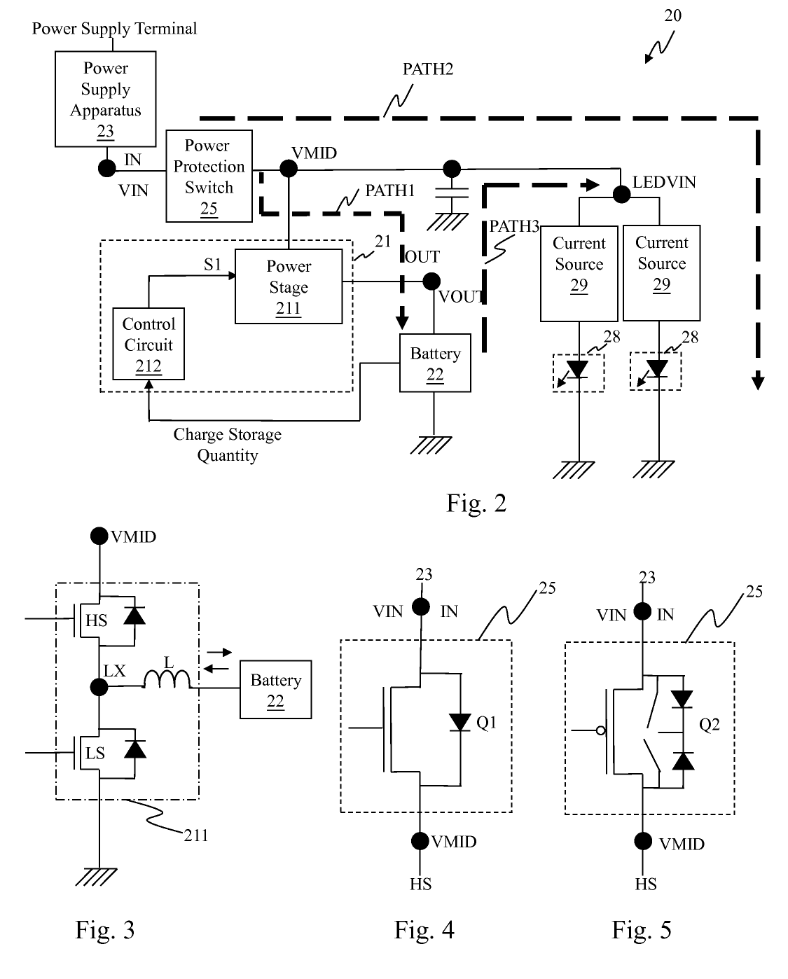

Please refer to FIGS. 2-3. FIG. 2 shows a block diagram, illustrating an embodiment of a hardware configuration where a control method for supplying power according to the present invention can be applied to. FIG. 3 shows an embodiment of the power stage of the present invention. The hardware configuration 20 of this embodiment includes a power supply apparatus 23, a bi-directional switching regulator 21, a group of power-receiving devices (e.g., plural current sources 29 and plural light emitting diodes (LEDs) 28) and a battery 22. In addition to the above-mentioned devices, the hardware configuration 20 can optionally include a power protection switch 25 when needed. The hardware configuration 20 for example can be a portable electronic device; the power supply apparatus 23 for example can be a travel adaptor; the LEDs 28 for example can be a torch or a flash in the portable electronic device. The group of power-receiving devices can include other devices, and the number of the current sources 29 and the number of the LEDs 28 can be modified depending on the practical need. The power supply apparatus 23, the bi-directional switching regulator 21 and the two current sources 29 are commonly coupled to a charging node VMID. Each current source 29 is coupled between a corresponding LED 28 and a node LEDVIN, i.e., each current source 29 is coupled between a corresponding LED 28 and the charging node VMID. The bi-directional switching regulator 21 is coupled between the charging node VMID and the battery 22, and the bi-directional switching regulator 21 converts an input voltage VIN at an input terminal IN to an output voltage VOUT at an output terminal OUT, or converts the output voltage VOUT to a voltage at the charging node VMID. As shown in FIG. 2, the input terminal IN is coupled between the power supply apparatus 23 and the charging node VMID, and the output terminal OUT is coupled between the bi-directional switching regulator 21 and the battery 22. The bi-directional switching regulator 21 includes a power stage 211 and a control circuit 212. The bi-directional switching regulator 21 can perform a buck conversion operation (buck mode) in one direction and a boost conversion operation (buck mode) in the other direction.

As shown in FIG. 3, the power stage 211 includes an upper gate switch HS, a lower gate switch LS and an inductor L. The upper gate switch HS, the lower gate switch LS and the inductor L are commonly and electrically connected to a switching node Lx. The power stage 211 is controlled by the control signal S1 generated by the control circuit 212. The upper gate switch HS for example can be a PMOS transistor or an NMOS transistor (illustrated as an NMOS transistor in FIG. 3); the lower gate switch N1 for example can be a PMOS transistor or an NMOS transistor (illustrated as an NMOS transistor in FIG. 3).

In the hardware configuration 20 of this embodiment, when the battery 22 requires to be charged, the hardware configuration 20 can supply power through a first path PATH1 (as shown in FIG. 2) from the power supply apparatus 23 via a power supply terminal to the battery 22 through a buck conversion operation of the power stage 211 of the bi-directional switching regulator 21. When the LEDs 28 require power (or the output capacitor requires power), on one hand, the hardware configuration 20 can supply power through a second path PATH2 (as shown in FIG. 2) from the power supply apparatus 23 to the LEDs 28 (the current through each LED 28 is controlled by the corresponding current source 29); or, on the other hand, the hardware configuration 20 can supply power through a third path PATH3 (as arrow shown in FIG. 2) from the battery 22 to the LEDs 28 (the current through each LED 28 is controlled by the corresponding current source 29) through a boost conversion operation of the power stage 211 of the bi-directional switching regulator 21. The details as to how the above-mentioned first path PATH1, second path PATH2 and third path PAHT3 are adapted for supplying power under different circumstances will be described below.

In certain applications of the present invention, a power protection switch 25 can be provided between the input terminal IN and the upper-gate switch HS, and such power protection switch 25 is capable of preventing a reverse current. Please refer to FIGS. 4-5, which show several embodiments of the power protection switch. The power protection switch 25 includes a transistor Q1 (as shown in FIG. 4) or a transistor Q2 whose parasitic diode polarity is adjustable (as shown in FIG. 5). In the embodiment shown in FIG. 4, the transistor Q1 has a parasitic diode whose anode is electrically connected to the input terminal IN and whose cathode electrically connected to the upper-gate switch HS. In other words, the polarity of the parasitic diode of the transistor Q1 is opposite to that of the upper-gate switch HS. Accordingly, when the voltage at the node connected to the upper-gate switch HS is higher than the input voltage Vin, the parasitic diode of the transistor Q1 is capable of preventing a reverse current from flowing in the reverse direction from the upper-gate switch HS to the input terminal IN. Or, for another example, as shown in FIG. 5, the transistor Q2 a parasitic diode whose polarity is adjustable. Therefore, when the voltage at the node connected to the upper-gate switch HS is higher than the input voltage Vin, the anode-cathode direction of the parasitic diode can be set opposite to the direction of the reverse current to prevent the reverse current from flowing in the reverse direction. And when the voltage at the upper-gate switch HS is lower than the input voltage Vin, to prevent a forward current from flowing in the forward direction from the input terminal IN to the upper-gate switch HS (e.g., when it is desired to stop operating the buck conversion of the bi-directional switching regulator 21), the anode-cathode direction of the parasitic diode can be set opposite to the direction of the forward current. Thus, the power protection switch 25 can protect the power source or control the bi-directional switching regulator 21.

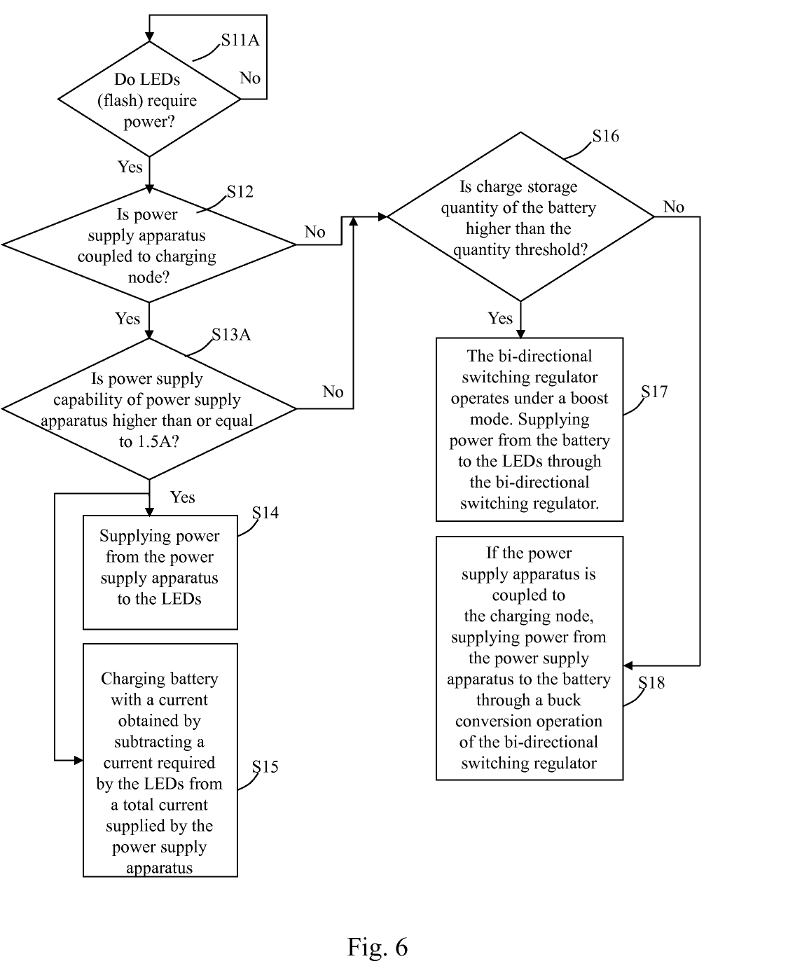

When the power supply apparatus 23 is coupled to the input terminal IN and when only one of the battery 22 or the LEDs 28 require power (i.e., in FIG. 2, only one of the first path PATH1 or the second path PATH 2 is required to supply power), the control method will be very simple. That is, the hardware configuration 20 simply needs to supply power from the power supply apparatus 23 to the power-receiving device that requires power. Nevertheless, in the case when both of the battery 22 and the LEDs 28 require power and it is uncertain whether the power supply apparatus 23 is coupled to the input terminal IN (for example: if the power supply apparatus 23 is not coupled to the input terminal IN, it is required to supply power from the battery 22 to the LEDs 28. However, under such circumstance, if the power supply apparatus 23 is suddenly coupled to the input terminal IN, there will be problems), the prior art fails to provide an effective priority control method. To overcome the drawbacks, the present invention proposes a control method for supplying power, which will be described as follow with reference to FIGS. 6-11, which show flowcharts illustrating several embodiments of the control method for supplying power according to the present invention. Note that the values of the voltage, current, or battery capacity described in the embodiments below are for illustrative purpose only, but not for limiting the scope of the present invention.

Please refer to FIG. 6 in conjugation with FIG. 2; FIG. 6 is a flowchart illustrating an embodiment of the control method for supplying power according to the present invention. First, in the step S11A, it is determined whether the LEDs 28 require power. When it is determined yes by the step S11A, it is preferred to supply power to the LEDs 28 from the power supply apparatus 23 via the power supply terminal if this is possible. Therefore, in the step S12, it is determined whether the power supply apparatus 23 is coupled to the input terminal IN. The judgment can be made for example according to whether a voltage level of the input terminal IN (i.e., the input voltage VIN) is at or above a certain level. When the power supply apparatus 23 is coupled to the input terminal IN (it is determined yes in the step S12), then, in the step S13A, the hardware configuration 20 determines whether a power supply capability of the power supply apparatus 23 is higher than a current required by the LEDs 28. For example, assuming that the LEDs 28 form an LED flash whose total current required is 1.5 A, when it is determined that the power supply capability (the current supply amount) of the power supply apparatus 23 is of 1.8 A, it indicates that the power supply capability of the power supply apparatus 23 is higher than the current required by the LED flash. Under such circumstance, the power supply apparatus 23 is capable of supplying the total power required by the LEDs 28 (it is determined yes in the step S13A). Therefore, on one hand, in the step S14, the hardware configuration 20 supplies power from the power supply apparatus 23 to the LEDs 28 (the current amount is controlled by the corresponding current source 29) through the path PATH2 (referring to FIG. 2); on the other hand, in the step S15, the hardware configuration 20 supplies power to the battery 22 through the path PATH1 (referring to FIG. 2), i.e., from the power supply apparatus 23 to the battery 22 through a buck conversion operation of the power stage 211 of the bi-directional switching regulator 21, with a remaining current obtained by subtracting a current required by the LEDs 28 from a total current supplied by the power supply apparatus (the step S15). For example, assuming that the LEDs 28 require a total current of 1.5 A and the power supply apparatus 23 is capable of supplying a current of 1.8 A, the hardware configuration 20 will meet the need of the LEDs 28 in higher priority, i.e., supply a current of 1.5 A to the LEDs 28, and supply the remaining current of 0.3 A to the battery 22 (1.8 A−1.5 A=0.3 A).

When it is determined that the power supply apparatus 23 is not coupled to the input terminal IN (it is determined no in the step S12), or, when it is determined that the power supply apparatus 23 is coupled to the input terminal IN but the power supply capability of the power supply apparatus 23 is lower than the current required by the LEDs 28 (it is determined yes in the step S12 and it is determined no in the step S13), then, in the step S16, the hardware configuration 20 determines whether a charge storage quantity of the battery 22 is higher than a quantity threshold.

In this embodiment, the charge storage quantity (the battery capacity) of the battery 22 can be represented by a state of charge (SOC) (%) or a voltage level (V). The battery capacity can be measured by various ways well known to those skilled in the art, which are therefore not redundantly described here. The quantity threshold can be set as a certain proportional value of the maximum battery capacity of the battery 22 depending on different representation of the charge storage quantity.

When it is determined yes in the step S16 (i.e., the charge storage quantity of the battery 22 is adequate to fulfill the need of the LEDs 28), in the step S17, the control signal S1 generated by the control circuit 212 controls the bi-directional switching regulator 21 to operate under a boost mode, and the hardware configuration 20 adopts the path PATH3 (referring to FIG. 2) to supply power to the LEDs 28 via the boost conversion operation of the power stage 211 of the bi-directional switching regulator 21. When it is determined no in the step S16 (i.e., the charge storage quantity of the battery 22 is inadequate to fulfill the need of the LEDs 28) and when it is determined that the power supply apparatus 23 is coupled to the input terminal IN (step S12), then, in the step S18, the hardware configuration 20 supplies power to the battery 22 via the buck conversion operation of the power stage 211 of the bi-directional switching regulator 21 (note that the step S18 is different from the step S15). When it is determined that the power supply apparatus 23 is not coupled to the input terminal IN (step S12) and when the charge storage quantity of the battery 22 is inadequate (step S16), the hardware configuration 20 enters a standby mode.

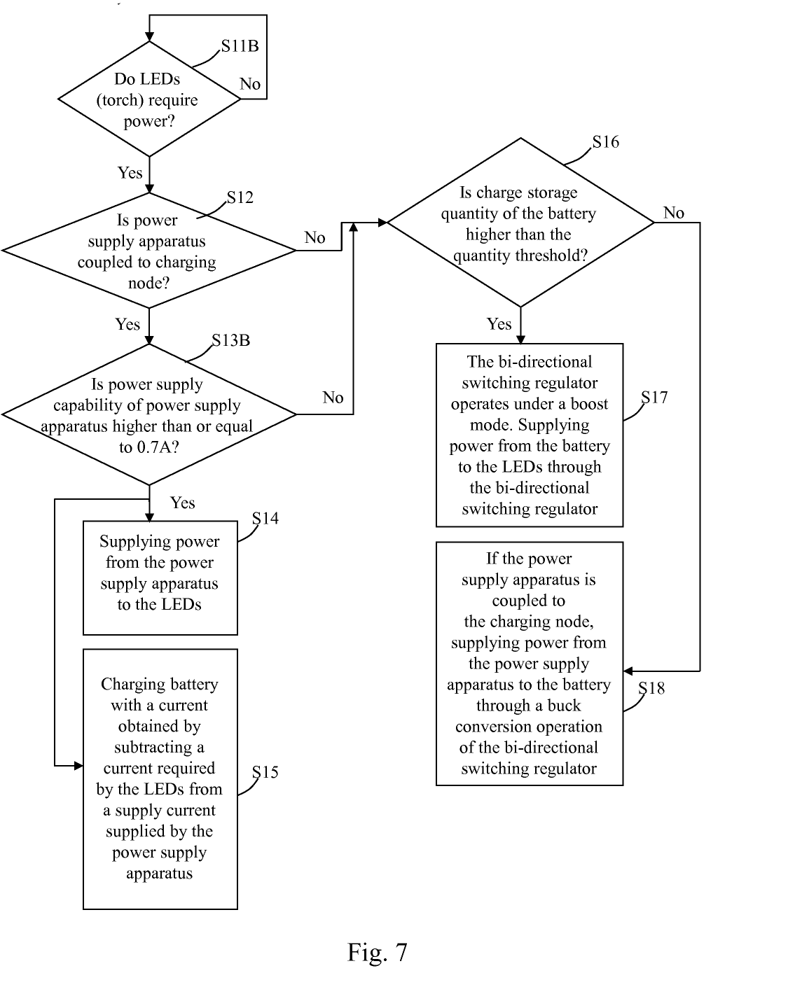

Please refer to FIG. 7 in conjugation with FIG. 2; FIG. 7 is a flowchart illustrating another embodiment of the control method for supplying power according to the present invention. The control method for supplying power of this embodiment is substantially the same as the control method for supplying power of the previous embodiment, but is different in that: the LEDs 28 of this embodiment form an LED torch, as shown in the step S11B in FIG. 7. And, it is assumed that the total current required by the LED torch is 0.7 A, as shown in the step S13B in FIG. 7. In addition to the differences in the application of the LEDs 28 (the LED flash or the LED torch) and the judgment criteria of the power supply capability of the power supply apparatus 23, the control method for supplying power of this embodiment operates according to substantially the same mechanism as the control method for supplying power of the previous embodiment, so it has substantially the same advantages and efficacies as the previous embodiment, which are not redundantly repeated here.

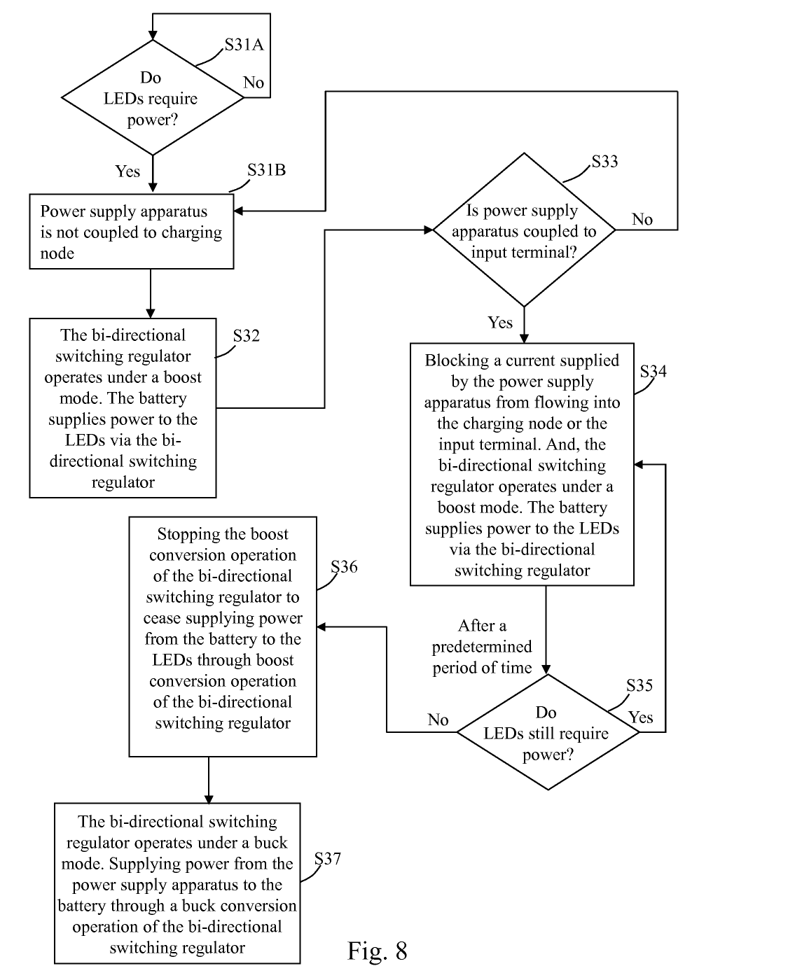

Please refer to FIG. 8 in conjugation with FIG. 2; FIG. 8 is a flowchart illustrating yet another embodiment of the control method for supplying power according to the present invention. This embodiment demonstrates how to deal with the situation wherein the power supply apparatus 23 is originally not coupled to the input terminal IN but later coupled to the input terminal IN when the battery 22 is supplying power to the LEDs 28. First, in the step S31A, the hardware configuration 20 determines whether the LEDs 28 requires power. As it is determined yes by the step S31A, in the step S31B, it is found that the power supply apparatus 23 is not coupled to the input terminal IN. Thus, in the step S32, the hardware configuration 20 in this embodiment adopts the path PATH3 (as shown in FIG. 2), i.e., the control signal S1 generated by the control circuit 212 controls the bi-directional switching regulator 21 to operate under a boost mode to supply power to the LEDs 28 from the battery 22. Subsequently, in the step S33, the hardware configuration 20 determines whether the power supply apparatus 23 is coupled to the input terminal IN. When it is determined that the power supply apparatus 23 is still not coupled to the input terminal IN (it is determined no in the step S33), the process returns to the step S32 and the hardware configuration 20 keeps adopting the path PATH3 to supply power to the LEDs 28 from the battery 22.

When it is determined that the power supply apparatus 23 is coupled to the input terminal IN (it is determined yes in the step S33), to avoid an undesirable conflict between the current in-flow and the boost conversion operation of the power stage 211, and/or to avoid interrupting the power supply to the LEDs 28, in the step S34, this embodiment blocks the power supply apparatus 23 so that the current does not flow into the input terminal IN or the charging node VMID. Under such circumstance, the hardware configuration 20 still adopts the path PATH3 (as shown in FIG. 2) to maintain the boost conversion operation of the bi-directional switching regulator 21, so that the hardware configuration 20 keeps supplying power to the LEDs 28 from the battery 22. The action “blocking the power supply apparatus 23” can be performed by disabling the power supply apparatus 23 temporarily or, if there is a switch disposed in the path between the power supply apparatus 23 and the charging node VMID, by turning OFF the switch.

After a predetermined period of time subsequent to the step S34, the hardware configuration 20 again determines whether the LEDs 28 still requires power (the step S35) (note that at this moment, the power supply apparatus 23 has been coupled to the input terminal IN). When it is determined yes in the step S35, the hardware configuration 20 returns to the step S34. When it is determined that the LEDs 28 no longer requires power (it is determined no in the step S35), the hardware configuration 20 ceases supplying power through the path PATH3 and the power stage 211 of the bi-directional switching regulator 21 stops operating under the boost mode (the step S36). Thereafter, the hardware configuration 20 adopts the path PATH1 (as shown in FIG. 2) to supply power to the battery 22 from the power supply apparatus 23 through the buck conversion operation of the power stage 211 of the bi-directional switching regulator 21 (the step S37). Later when the LEDs requires power again, the hardware configuration 20 can turn to the flowchart shown in FIGS. 6-7 (because the power supply apparatus 23 has been coupled to the input terminal IN).

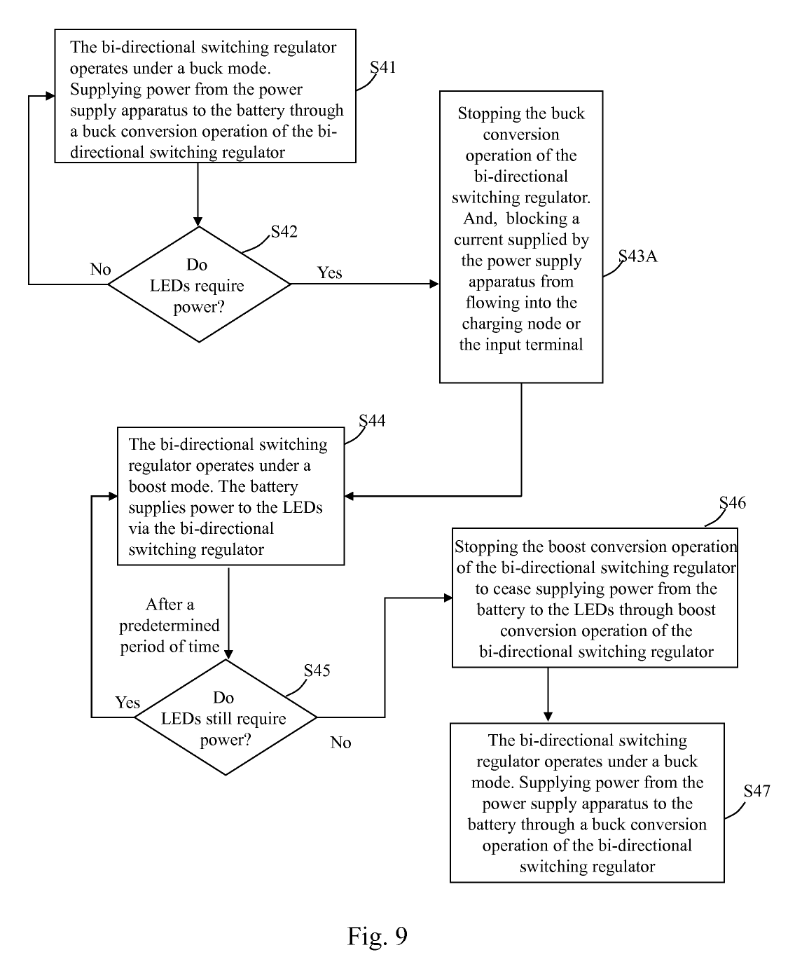

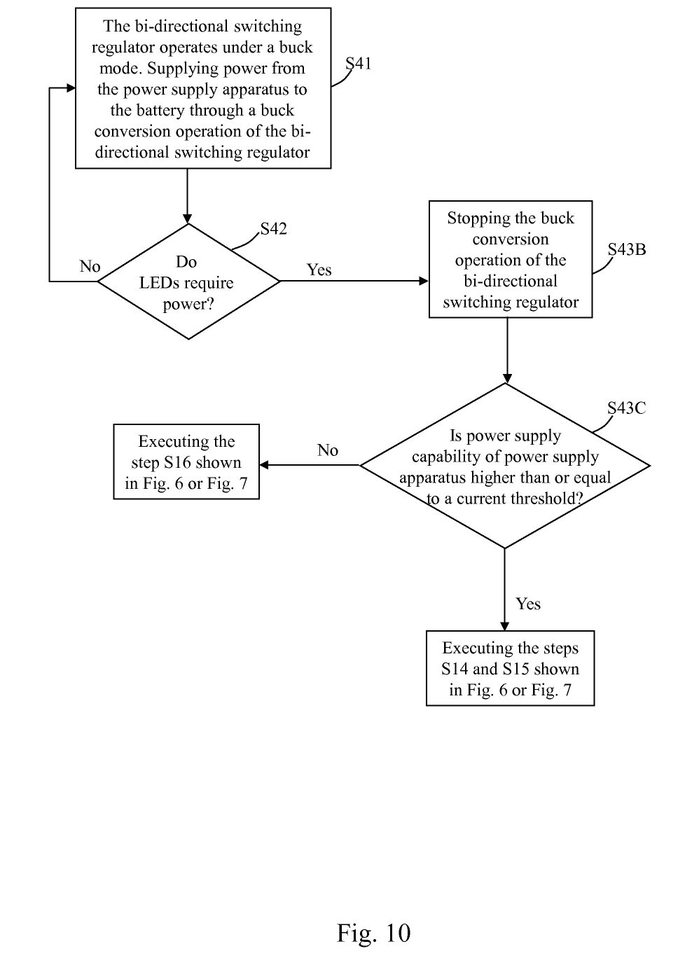

Please refer to FIG. 9 in conjugation with FIG. 2; FIG. 9 is a flowchart illustrating still another embodiment of the control method for supplying power according to the present invention. This embodiment demonstrates how to deal with the situation wherein the power supply apparatus 23 is originally supplying power to the battery 22 but later the LEDs 28 suddenly require power when the power supply apparatus 23 is supplying power to the battery 22. First, in the step S41, the hardware configuration 20 in this embodiment adopts the path PATH1 (as shown in FIG. 2) to supply power to the battery 22 from the power supply apparatus 23 through the buck conversion operation of the power stage 211 of the bi-directional switching regulator 21. Next, in the step S42, the hardware configuration 20 determines whether the LEDs require power. When the LEDs does not require power (it is determined no in the step S42), the hardware configuration 20 keeps adopting the path PATH1 to supply power to the battery 22. When the LEDs 28 requires power (it is determined yes in the step S42), the hardware configuration 20 stops the buck conversion operation of the power stage 211 to cease supplying power to the battery 22, and blocks a current supplied by the power supply apparatus 23 from flowing into the input terminal IN or the charging node VMID. Subsequently, in the step S44, the control signal S1 generated by the control circuit 212 of the hardware configuration 20 controls the power stage 211 of the bi-directional switching regulator 21 to operate under a boost mode and adopt the path PATH3 to supply power to the LEDs 28 from the battery 22.

Next, after a predetermined period of time subsequent to the step S44, in the step S45, it is determined whether the LEDs 28 still require power. If it is determined yes in the step S45, the process returns back to the step S44; If it is determined no in the step S45, subsequently, in the step S46, when the LEDs 28 no longer require power, the control signal S1 generated by the control circuit 212 of the hardware configuration 20 stops the boost conversion operation of the power stage 211 of the bi-directional switching regulator 21 and ceases adopting the path PATH3, thus ceasing supplying power to the LEDs 28 from the battery 22.

Next, in the step S47, the hardware configuration 20 adopts the path PATH1 (as shown in FIG. 2) to supply power to the battery 22 from the power supply apparatus 23 through the buck conversion operation of the power stage 211 of the bi-directional switching regulator 21.

In the above embodiment, in the step S43A of FIG. 9, the hardware configuration 20 blocks the current supplied by the power supply apparatus 23 from flowing into the input terminal IN or the charging node VMID regardless of the power supply capability of the power supply apparatus 23. Nevertheless, this is not the only way. Please refer to FIG. 10 in conjugation with FIG. 2; FIG. 10 is a flowchart illustrating still another embodiment of the control method for supplying power according to the present invention. In this embodiment of FIG. 10, when the LEDs 28 requires power (it is determined yes in the step S42), in the step S43B, the hardware configuration 20 stops the buck conversion operation of the power stage 211 to cease supplying power to the battery 22, and in the step S43C, it is determined whether a power supply capability of the power supply apparatus 23 is higher than or equal to a current threshold (this current threshold corresponds to a current required by the LEDs 28, such as a current of 1.5 A or 0.7 A as described above). When the power supply capability of the power supply apparatus 23 is higher than or equal to the current threshold, the hardware configuration 20 can execute the steps of S14 and S15 shown in FIG. 6 or FIG. 7. When the power supply capability of the power supply apparatus 23 is lower than the current threshold, the hardware configuration 20 can execute the step S16 shown in FIG. 6 or FIG. 7.

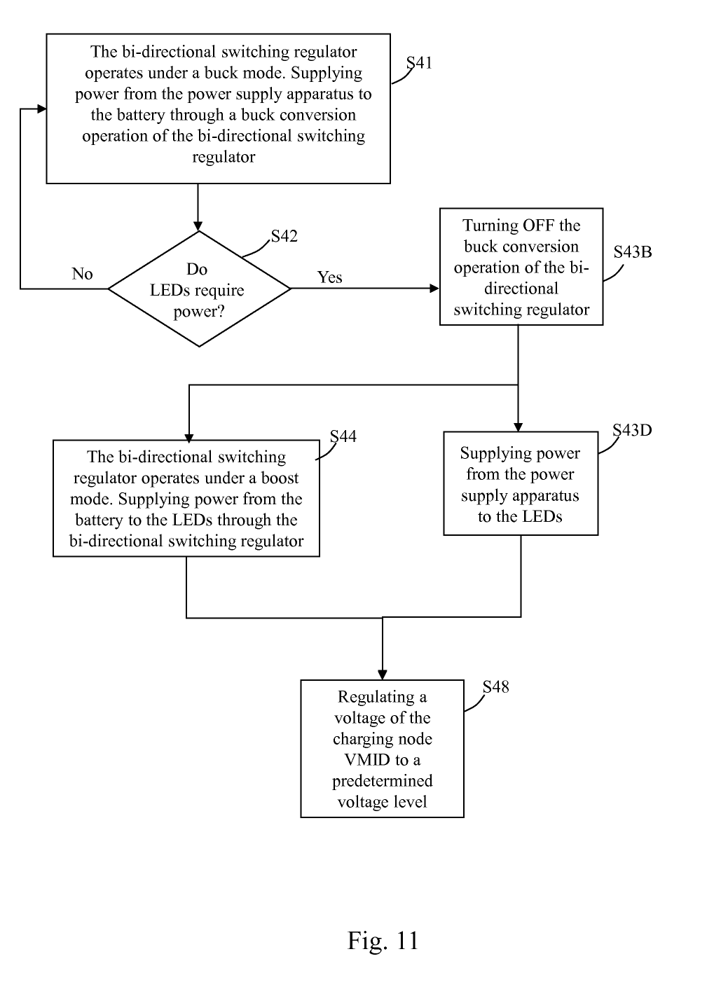

Please refer to FIG. 11 in conjugation with FIG. 2; FIG. 11 is a flowchart illustrating still another embodiment of the control method for supplying power according to the present invention. In this embodiment, when the LEDs 28 requires power (it is determined yes in the step S42), in the step S43B, this embodiment stops the buck conversion operation of the power stage 211. Next, the hardware configuration 20 executes the step S43D and the step S44 at the same time to supply power to the LEDs 28 from both the power supply apparatus 23 and the battery 22. In this embodiment, the hardware configuration 20 does not control the current, but instead, it regulates a voltage of the charging node VMID to a predetermined voltage level.

It should be noted that the present invention is not limited to the aforesaid sequence of the steps; while the steps are described in a certain order with regard to FIGS. 6-11, the sequence of the steps can be changed in other embodiments, and non-dependent steps can be implemented in parallel. For example, the sequence of the steps for determining whether the LEDs require power and whether the power supply apparatus is coupled to the charging node can be interchanged, or, these steps can be implemented in parallel.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, in performing a comparison described in the above-mentioned embodiments, as one of average skill in the art will appreciate, the term. “higher than” or “lower than”, as may be used herein, may comprise “equal to” or may not comprise “equal to”. For another example, in the above-mentioned embodiments, the power-receiving devices in addition to the battery are shown to be the LEDs (and the corresponding current sources that controls the LEDs), but this is only an example and the power-receiving devices can also be any other devices or circuits that require current. For yet another example, in FIG. 3, the bi-directional switching regulator 21 can be connected differently (the connections to the charging node VMID and the battery 22 are interchanged), such that it becomes a boost conversion operation to supply power to the battery and it becomes a buck conversion operation to supply power to the LEDs from the battery; this is also within the scope of the present invention. In view of the foregoing, the spirit of the present invention should cover all such and other modifications and variations, which should be interpreted to fall within the scope of the following claims and their equivalents.

What is claimed is:

1. A control method for supplying power through a first path from a power supply apparatus to a battery via a bi-directional switching regulator under a charging mode and supplying power through a second path from the power supply apparatus to at least one power-receiving device under the charging mode, or supplying power through a third path from the battery to the at least one power-receiving device via the bi-directional switching regulator under a power supply mode, wherein the power supply apparatus, the bi-directional switching regulator and the at least one power-receiving device are commonly coupled to a charging node under the charging mode and the bi-directional switching regulator is coupled between the charging node and the battery; the control method for supplying power comprising the steps of:
(a) determining whether the at least one power-receiving device requires power and whether the power supply apparatus is coupled to the charging node;
(b) when both questions of step (a) are determined yes, determining whether a power supply capability of the power supply apparatus is higher than a current threshold;
(c) when it is determined yes in step (b), supplying power through the second path from the power supply apparatus to the at least one power-receiving device;
(d) when it is determined no in step (b), determining whether a charge storage quantity of the battery is higher than a quantity threshold;
(e) when it is determined yes in step (d), supplying power through the third path from the battery to the at least one power-receiving device via the bi-directional switching regulator; and
(f) when it is determined no in step (d), and when the power supply apparatus is coupled to the charging node, supplying power through the first path from the power supply apparatus to the battery via the bi-directional switching regulator.

2. The control method for supplying power of claim 1, wherein the step (c) further comprises:
when it is determined yes in step (b), charging the battery through the first path with a remaining current obtained by subtracting a current required by the at least one power-receiving device from a current supplied by the power supply apparatus.

3. The control method for supplying power of claim 1, further comprising:
when it is determined by step (a) that the at least one power-receiving device requires power and the power supply apparatus is not coupled to the charging node, executing the following steps:
(d1) determining whether the charge storage quantity of the battery is higher than the quantity threshold; and
(e1) when it is determined yes in step (d1), supplying power through the third path from the battery to the at least one power-receiving device via the bi-directional switching regulator.

4. The control method for supplying power of claim 1, wherein the at least one power-receiving device includes at least one light emitting diode (LED).

5. The control method for supplying power of claim 1, wherein the quantity threshold is represented by a state of charge (SOC) or a voltage level of the battery.

6. The control method for supplying power of claim 1, wherein:
when supplying power from the power supply apparatus to the battery via the bi-directional switching regulator, the bi-directional switching regulator operates under a buck mode to perform a buck conversion; and
when supplying power from the battery to the at least one power-receiving device via the bi-directional switching regulator, the bi-directional switching regulator operates under a boost mode to perform a boost conversion.

7. A control method for supplying power through a first path from a power supply apparatus to a battery via a bi-directional switching regulator under a charging mode and supplying power through a second path from the power supply apparatus to at least one power-receiving device under the charging mode, or supplying power through a third path from the battery to the at least one power-receiving device via the bi-directional switching regulator under a power supply mode, wherein the power supply apparatus, the bi-directional switching regulator and the at least one power-receiving device are commonly coupled to a charging node under the charging mode and the bi-directional switching regulator is coupled between the charging node and the battery; the control method for supplying power comprising the steps of:
(a) when the at least one power-receiving device requires power but the power supply apparatus is not coupled to the charging node, supplying power through the third path from the battery to the at least one power-receiving device via the bi-directional switching regulator;
(b) subsequent to step (a), determining whether the power supply apparatus is coupled to the charging node;
(c) when it is determined no in step (b), keeping supplying power from the battery to the at least one power-receiving device via the bi-directional switching regulator; and
(d) when it is determined yes in step (b), blocking a current supplied by the power supply apparatus from flowing into the charging node and keeping supplying power from the battery to the at least one power-receiving device via the bi-directional switching regulator.

8. The control method for supplying power of claim 7, further comprising:
(e) after a predetermined period of time subsequent to the step (d), determining whether the at least one power-receiving device still requires power;
(f) when it is determined yes in step (e), keeping blocking the current supplied by the power supply apparatus from flowing into the charging node and keeping supplying power from the battery to the at least one power-receiving device via the bi-directional switching regulator; and
(g) when it is determined no in step (e), ceasing blocking the current supplied by the power supply apparatus from flowing into the charging node and ceasing supplying power from the battery to the at least one power-receiving device through the bi-directional switching regulator, and supplying power through the first path from the power supply apparatus to the battery via the bi-directional switching regulator.

9. The control method for supplying power of claim 7, wherein the at least one power-receiving device includes at least one light emitting diode (LED).

10. The control method for supplying power of claim 7, wherein:
when supplying power from the power supply apparatus to the battery via the bi-directional switching regulator, the bi-directional switching regulator operates under a buck mode to perform a buck conversion; and
when supplying power from the battery to the at least one power-receiving device via the bi-directional switching regulator, the bi-directional switching regulator operates under a boost mode to perform a boost conversion.

11. A control method for supplying power through a first path from a power supply apparatus to a battery via a bi-directional switching regulator under a charging mode and supplying power through a second path from the power supply apparatus to at least one power-receiving device under the charging mode, or supplying power through a third path from the battery to the at least one power-receiving device via the bi-directional switching regulator under a power supply mode, wherein the power supply apparatus, the bi-directional switching regulator and the at least one power-receiving device are commonly coupled to a charging node under the charging mode and the bi-directional switching regulator is coupled between the charging node and the battery; the control method for supplying power comprising the steps of:
(a) supplying power through the first path from the power supply apparatus to the battery via the bi-directional switching regulator;
(b) determining whether the at least one power-receiving device requires power;
(c) when it is determined no in step (b), keeping supplying power through the first path from the power supply apparatus to the battery via the bi-directional switching regulator;
(d) when it is determined yes in step (b), ceasing supplying power from the power supply apparatus to the battery via the bi-directional switching regulator and blocking a current supplied by the power supply apparatus from flowing into the charging node; and
(e) subsequent to the step (d), supplying power through the third path from the battery to the at least one power-receiving device via the bi-directional switching regulator.

12. The control method for supplying power of claim 11, further comprising:
(e) after a predetermined period of time subsequent to the step (d), determining whether the at least one power-receiving device still requires power;
(f) when it is determined yes in step (e), keeping blocking the current supplied by the power supply apparatus from flowing into the charging node and keeping supplying power from the battery to the at least one power-receiving device via the bi-directional switching regulator; and
(g) when it is determined no in step (e), ceasing blocking the current supplied by the power supply apparatus from flowing into the charging node and ceasing supplying power from the battery to the at least one power-receiving device via the bi-directional switching regulator, and supplying power through the first path from the power supply apparatus to the battery via the bi-directional switching regulator.

13. The control method for supplying power of claim 11, wherein the at least one power-receiving device includes at least one light emitting diode (LED).

14. The control method for supplying power of claim 11, wherein:
when supplying power from the power supply apparatus to the battery via the bi-directional switching regulator, the bi-directional switching regulator operates under a buck mode to perform a buck conversion; and
when supplying power from the battery to the at least one power-receiving device via the bi-directional switching regulator, the bi-directional switching regulator operates under a boost mode to perform a boost conversion.

15. A control method for supplying power through a first path from a power supply apparatus to a battery via a bi-directional switching regulator under a charging mode and supplying power through a second path from the power supply apparatus to at least one power-receiving device under the charging mode, or supplying power through a third path from the battery to the at least one power-receiving device via the bi-directional switching regulator under a power supply mode, wherein the power supply apparatus, the bi-directional switching regulator and the at least one power-receiving device are commonly coupled to a charging node under the charging mode and the bi-directional switching regulator is coupled between the charging node and the battery; the control method for supplying power comprising the steps of:
(a) supplying power through the first path from the power supply apparatus to the battery via the bi-directional switching regulator;
(b) determining whether the at least one power-receiving device requires power;
(c) when it is determined no in step (b), keeping supplying power through the first path from the power supply apparatus to the at least one power-receiving device via the bi-directional switching regulator;
(d) when it is determined yes in step (b), determining whether a power supply capability of the power supply apparatus is higher than a current threshold;
(e) when it is determined yes in step (d), supplying power through the second path from the power supply apparatus to the at least one power-receiving device;
(f) when it is determined no in step (d), determining whether a charge storage quantity of the battery is higher than a quantity threshold;
(g) when it is determined yes in step (f), supplying power through the third path from the battery to the at least one power-receiving device via the bi-directional switching regulator; and
(h) when it is determined no in step (f), supplying power through the first path from the power supply apparatus to the battery via the bi-directional switching regulator.

16. The control method for supplying power of claim 15, wherein the step (e) further comprises:
when it is determined yes in step (d), charging the battery through the first path with a remaining current obtained by subtracting a current required by the at least one power-receiving device from a current supplied by the power supply apparatus.

17. The control method for supplying power of claim 15, wherein the at least one power-receiving device includes at least one light emitting diode (LED).

18. The control method for supplying power of claim 15, wherein the quantity threshold is represented by a state of charge (SOC) or a voltage level of the battery.

19. The control method for supplying power of claim 15, wherein:
when supplying power from the power supply apparatus to the battery via the bi-directional switching regulator, the bi-directional switching regulator operates under a buck mode to perform a buck conversion; and
when supplying power from the battery to the at least one power-receiving device via the bi-directional switching regulator, the bi-directional switching regulator operates under a boost mode to perform a boost conversion.

20. A control method for supplying power through a first path from a power supply apparatus to a battery via a bi-directional switching regulator under a charging mode and supplying power through a second path from the power supply apparatus to at least one power-receiving device under the charging mode, or supplying power through a third path from the battery to the at least one power-receiving device via the bi-directional switching regulator under a power supply mode, wherein the power supply apparatus, the bi-directional switching regulator and the at least one power-receiving device are commonly coupled to a charging node under the charging mode and the bi-directional switching regulator is coupled between the charging node and the battery; the control method for supplying power comprising the steps of:
(a) supplying power through the first path from the power supply apparatus to the battery via the bi-directional switching regulator;
(b) determining whether the at least one power-receiving device requires power;
(c) when it is determined no in step (b), keeping supplying power from the power supply apparatus to the battery via the bi-directional switching regulator;
(d) when it is determined yes in step (b), supplying power from both the power supply apparatus and the battery to the at least one power-receiving device; and
(e) regulating a voltage of the charging node to a predetermined voltage level.

21. The control method for supplying power of claim 20, wherein the at least one power-receiving device includes at least one light emitting diode (LED).

22. The control method for supplying power of claim 20, wherein:
when supplying power from the power supply apparatus to the battery via the bi-directional switching regulator, the bi-directional switching regulator operates under a buck mode to perform a buck conversion; and
when supplying power from the battery to the at least one power-receiving device via the bi-directional switching regulator, the bi-directional switching regulator operates under a boost mode to perform a boost conversion.
